(19) United States
(12) Patent Application Publication
(10) Pub. No.: US 2025/0387776 A1
(43) Pub. Date: Dec. 25, 2025

(54) ADSORBENT IN WHICH METAL-ORGANIC FRAMEWORK IS FILLED IN THE PORE SPACE OF THE CARRIER, METHOD OF MANUFACTURING THE SAME, AND A METHOD OF RECOVERING RARE EARTH METALS FROM A WASTE PERMANENT MAGNET USING AN ADSORBENT IN WHICH METAL-ORGANIC FRAMEWORK IS FILLED IN THE PORE SPACE OF THE CARRIER

(71) Applicant: KOREA INSTITUTE OF SCIENCE AND TECHNOLOGY, Seoul (KR)

(72) Inventors: Kyung-Won JUNG, Seoul (KR); Jae Woo CHOI, Seoul (KR); Youngkyun JUNG, Seoul (KR); Eun CHO, Seoul (KR)

(21) Appl. No.: 19/076,805

(22) Filed: Mar. 11, 2025

(30) Foreign Application Priority Data
Jun. 20, 2024 (KR) 10-2024-0080013

(51) Int. Cl. B01J 20/22; B01J 20/32

(52) U.S. Cl. CPC B01J 20/226; B01J 20/321; B01J 20/3219

(57) ABSTRACT

The present invention relates to an adsorbent in which a metal-organic framework is filled within the pore space of a carrier and a method of manufacturing the same, as well as a method of recovering rare earth metals from waste permanent magnets using an adsorbent in which a metal-organic framework is filled within the pore space of a carrier.

### DESCRIPTION OF GOVERNMENT-SPONSORED RESEARCH

This invention was carried out with the support of Ministry of Science and ICT under a research project of Unique Project identification number: 2710016184 and Project identification number: 2020M3H4A3106366 titled “Developing customized module to enhance applicability of reactive filter under extreme environment”, as part of the research project of “Development of Nanomaterial technology” managed by the National Research Foundation of Korea from Jan. 1 to Dec. 31, 2024.

### CROSS REFERENCE TO RELATED APPLICATION

The present application claims priority to Korean Patent Application No. 10-2024-0080013, filed on Jun. 20, 2024, the entire contents of which are hereby incorporated by this reference.

### BACKGROUND OF THE INVENTION

### Field of the Invention

The present invention relates to an adsorbent in which a metal-organic framework is filled within the pore space of a carrier and a method of manufacturing the same, as well as a method of recovering rare earth metals from waste permanent magnets using an adsorbent in which a metal-organic framework is filled within the pore space of a carrier. More specifically, the present invention aims to provide an adsorbent in which a metal-organic framework is filled within the pore space of a carrier and a method of manufacturing the same, which are capable of effectively recovering the metal-ion-adsorbed metal-organic framework while preventing the activity of metal-organic framework from being degraded through a structure in which the metal-organic framework nanoparticles are loaded in the form of being filled within the pore network space inside the carrier. Additionally, the present invention aims to provide a method of recovering rare earth metals from waste permanent magnets using an adsorbent in which a metal-organic framework is filled within the pore space of a carrier.

### Description of the Related Art

Rare earth metals are widely used in various advanced industries. As an example, rare earth metal-containing rare earth permanent magnets are applied to charging batteries used in hybrid vehicles, wind turbine motors, radar systems, and more, and their demand is on the rise.

Since rare earth metals have limited reserves, the method of recovering and recycling rare earth metals from waste components has naturally been considered. Among the methods for recovering rare earth metals, the method using an adsorbent is the most effective in terms of recovery efficiency and economic feasibility.

Meanwhile, research on metal-organic frameworks (MOF) has been active recently. Metal-organic frameworks (MOFs) are known for having a very large surface area, being thermally and chemically stable, and exhibiting excellent adsorption capacities for metal ions or organic pollutants in water. Therefore, research is also being conducted on the use of metal-organic frameworks as adsorbents for rare earth metals.

However, since metal-organic frameworks are synthesized in the form of nanoparticles, applying these nanoscale metal-organic frameworks to the rare earth metal recovery process may allow for the recovery of rare earth metals, but recovering the metal-organic framework, which is an adsorbent, would inevitably be difficult (see Non-patent Document 1).

As a solution to this, methods have been proposed, such as combining nanoscale metal-organic frameworks with magnetic particles (see Non-patent Document 2) or fixing nanoscale metal-organic frameworks onto a support (e.g., alginate beads) (see Non-patent Document 3). However, synthesizing with magnetic particles inevitably increases manufacturing costs, and the method of fixing onto a support leads to a reduction in the activity (active site) of the metal-organic framework, which in turn decreases the recovery efficiency.

In addition, prior patents related to the present invention are described in Patent Documents 1 to 3. Patent Document 1 relates to a gas or liquid separation membrane with a structure in which an MOF layer is stacked on a porous polymer membrane. Patent Document 2 presents a material in which an MOF is covalently bonded to the surface of fibers as a material for adsorbing gases or liquids. Patent Document 3 proposes a structure in which a mesh-like metal-organic framework is formed on nanofibers as a material for adsorbing harmful gases or fine dust.

### SUMMARY OF THE INVENTION

The present invention has been made in effort to solve the problems as described above, and an object of the present invention is to provide an adsorbent in which a metal-organic framework is filled within the pore space of a carrier, along with a method of manufacturing the same, which are capable of recovering the metal-ion-adsorbed metal-organic framework while preventing the activity of metal-organic framework from being degraded through a structure in which the metal-organic framework nanoparticles are loaded in the form of being filled within the pore network space inside the carrier.

In addition, the present invention has another object of providing a method of recovering rare earth metals from waste permanent magnets using an adsorbent in which a metal-organic framework is filled within the pore space of a carrier.

To achieve the aforementioned objects, there is provided an adsorbent in which a metal-organic framework is filled within a pore space of a carrier, according to the present invention. The adsorbent may include: a carrier having a shell layer on a surface thereof and pores inside; and metal-organic framework particles loaded in a form of being filled in the pore space.

The shell layer may be provided with surface pores that connect an inside and an outside of the carrier, and metal ions in water may flow into the inside of the carrier through the surface pores.

A size of the surface pores may be smaller than a size of the metal-organic framework particles, preventing the metal-organic framework particles from leaking out of the carrier. In addition, a size of the surface pores may be smaller than a size of solids in water, so that the solids in water do not flow into the carrier.

The carrier may be made of a polymeric material having hydrophilic functional groups.

The carrier may be made of any one of polyacrylonitrile (PAN), polymethylmethacrylate (PMMA), polyacrylic acid (PAA), polyurethane (PU), polyimides (PI), polyaniline (PANI), polyvinyl alcohol (PVA), or polyvinylpyrrolidone (PVP), or a combination thereof.

The metal-organic framework particles may be made of any one of ZIF-series metal-organic frameworks, HKUST-1, MIL-88B, CAU-1, or MOF-5, or a combination thereof.

Metal ions in water may flow into the carrier through surface pores of the shell layer and be adsorbed onto the metal-organic framework particles.

There is provided a method of manufacturing an adsorbent in which a metal-organic framework is filled within a pore space of a carrier, according to the present invention. The method may include: manufacturing a carrier having a shell layer and pores; and allowing synthesis of metal-organic framework particles to proceed within the pore space of the carrier.

The manufacturing of the carrier having the shell layer and pores may include: preparing a carrier solution and a curing solution; dropping the carrier solution into the curing solution one drop at a time to form the carrier with the shell layer and pores by the solvent exchange reaction and an action of osmotic pressure, and surface pores that connect an inside and an outside of the carrier may be formed in the shell layer during the forming of the carrier with the shell layer and pores.

The carrier solution may be a solution in which a carrier material is dissolved and the carrier material may be made of a polymeric material having hydrophilic functional groups.

The allowing synthesis of metal-organic framework particles to proceed within the pore space of the carrier may include: immersing the carrier in a ligand solution to fill the pore space of the carrier with the ligand solution; and immersing the carrier filled with the ligand solution in a metal solution and allowing metal ions and ligands to react within the pore space to form the metal-organic framework.

The allowing synthesis of metal-organic framework particles to proceed within the pore space of the carrier may include: immersing the carrier in a metal solution to fill the pore space of the carrier with metal ions; and immersing the carrier filled with the metal ions in a ligand solution and allowing the metal ions and ligands to react to form the metal-organic framework.

There is provided a method of manufacturing an adsorbent in which a metal-organic framework is filled within a pore space of a carrier, according to another aspect of the present invention. The method may include: manufacturing a PAN carrier with a shell layer and pores; synthesizing Zn-ZIF-L particles within a pore space of the PAN carrier; and converting the Zn-ZIF-L particles into ZIF-8 particles.

The manufacturing of the PAN carrier having the shell layer and pores may include: preparing a PAN solution and a curing solution; dropping the PAN solution into the curing solution one drop at a time to form the PAN carrier with the shell layer and pores by the solvent exchange reaction and an action of osmotic pressure, and surface pores that connect an inside and an outside of the PAN carrier may be formed in the shell layer during the forming of the PAN carrier with the shell layer and pores.

The synthesizing of Zn-ZIF-L particles within the pore space of the PAN carrier may include: immersing the PAN carrier in a ligand solution to fill pores of the PAN carrier with the ligand solution; and immersing the PAN carrier filled with the ligand solution in a Zn solution and allowing Zn²⁺ ions and ligands to react within the pore space and form Zn-ZIF-L particles.

The converting of the Zn-ZIF-L particles into the ZIF-8 particles may include: immersing the PAN carrier, filled with the Zn-ZIF-L particles in the pore space of the PAN carrier, in a solution to convert the Zn-ZIF-L particles into the ZIF-8 particles.

A content of PAN in the PAN solution is 5 to 15 wt %.

There is provided a method of recovering rare earth metals from waste permanent magnets using an adsorbent in which a metal-organic framework is filled within a pore space of a carrier, according to the present invention. The method may include: immersing a waste permanent magnet including iron (Fe), neodymium (Nd), and dysprosium (Dy) in a solution with a pH of 4 to 7; and adding the adsorbent as described above into the solution.

The adsorbent in which a metal-organic framework is filled within the pore space of a carrier, the method of manufacturing the same, and the method of recovering rare earth metals from waste permanent magnets using the adsorbent in which a metal-organic framework is filled within the pore space of a carrier, according to the present invention, have the following effects.

Since the metal-organic framework, which has excellent metal ion adsorption capacity, exists in the form of being filled within the pore space inside the carrier, rather than being embedded in the carrier, it is possible to prevent the degradation of the activity of the metal-organic framework by the carrier.

### BRIEF DESCRIPTION OF THE DRAWINGS

FIG. 1 is a schematic view illustrating an adsorbent in which a metal-organic framework is filled within the pore space of a carrier according to the present invention.

FIG. 2 is a flowchart for describing a method of manufacturing an adsorbent in which a metal-organic framework is filled within the pore space of a carrier according to the present invention.

FIG. 3 is a reference view for describing the process of manufacturing a carrier with a pore network.

FIG. 4 is a reference view illustrating the process of forming ZIF-8 particles in the pore network of a carrier (PMC).

FIG. 5 is an SEM image of the PMC manufactured according to Experimental Example 1.

FIG. 6 is a PMC image reconstructed from the micro CT image of the PMC manufactured according to Experimental Example 1.

FIG. 7 illustrates photographs of PMC manufactured with varying PAN content applied according to Experimental Example 1.

FIG. 8 illustrates the SEM analysis results for PMC5 to PMC15 manufactured with PAN content of 5 to 15 wt % applied.

FIG. 9 illustrates the results of measuring the porosity and average pore size of PMC5 to PMC15.

FIG. 10 illustrates photographs taken after performing permeability experiments on PMC5 to PMC15.

FIG. 11 is the results illustrating the diameter changes of PMC when varying drop rates were applied.

FIG. 12 illustrates the XRD analysis results for Zn-ZIF-L@PMC manufactured according to Method I and Method II, respectively.

FIG. 13 illustrates the SEM-EDS analysis results for Zn-ZIF-L@PMC manufactured according to Method I and Method II, respectively.

FIG. 14 illustrates photographs taken during the synthesis process according to Method I and Method II.

FIG. 15 illustrates the amount of Zn-ZIF-L synthesized according to Method I and Method II.

FIG. 16A and FIG. 16B illustrate the FT-IR and XRD analysis results for ZIF-8@PMC manufactured according to Experimental Example 3.

FIG. 17 illustrates the micro CT image and reconstructed image of ZIF-8@PMC.

FIG. 18 illustrates the SEM analysis results for Zn-ZIF-L@PMC and ZIF-8@PMC.

FIG. 19 illustrates the FT-IR analysis results for ZIF-8@PMC.

FIG. 20 illustrates the results of calculating the weight ratio of ZIF-8 in ZIF-8@PMC and ZIF-8/PMC, respectively.

FIG. 21 illustrates the SEM-EDS analysis results for ZIF-8/PMC.

FIG. 22A illustrates the adsorption amounts of ZIF-8@PMC and ZIF-8/PMC for neodymium (Nd), respectively and FIG. 22B illustrates the adsorption amounts of ZIF-8@PMC and ZIF-8/PMC for dysprosium (Dy), respectively.

FIG. 23 illustrates the results of measuring the maximum adsorption amounts of ZIF-8@PMC for neodymium (Nd) and dysprosium (Dy), respectively.

FIG. 24 illustrates the adsorption experiment results with respect to a solution simulating the eluate of waste permanent magnets.

FIG. 25A and FIG. 25B illustrate the experimental results for the adsorption performance of spherical ZIF-8@PMC and hemispherical ZIF-8@PMC with respect to a solution simulating the eluate of waste permanent magnets.

FIG. 26 illustrates the experimental results for the adsorption performance of ZIF-8@PMC after regeneration.

FIG. 27A and FIG. 27B illustrate the experimental results for evaluating the stability in water of ZIF-8@PMC.

FIG. 28A and FIG. 28B illustrate the experimental results for evaluating the pressure drop characteristics of ZIF-8@PMC.

### DETAILED DESCRIPTION OF THE INVENTION

The present invention proposes a technology that combines a millimeter-sized carrier with a metal-organic framework. Through this combination, the excellent metal ion adsorption capacity of the metal-organic framework is fully utilized, while enabling easy recovery of the carrier.

As described above in the “Background of the Invention,” the technology of combining a metal-organic framework with a support to facilitate the recovery of the adsorbent is also disclosed in Non-patent Document 3. However, in case of Non-patent Document 3, since the metal-organic framework is only provided on the surface of the support and exists in a form embedded in the support, the contact area (active site) of the metal-organic framework that can come into contact with metal ions is reduced, leading to a decrease in the recovery efficiency of the metal ions.

Therefore, in combining the metal-organic framework with a carrier for the ease of recovery of the adsorbent, it is necessary to prevent or minimize the reduction of the contact area of the metal-organic framework due to the carrier, in order to avoid a decrease in the metal ion adsorption capacity of the metal-organic framework.

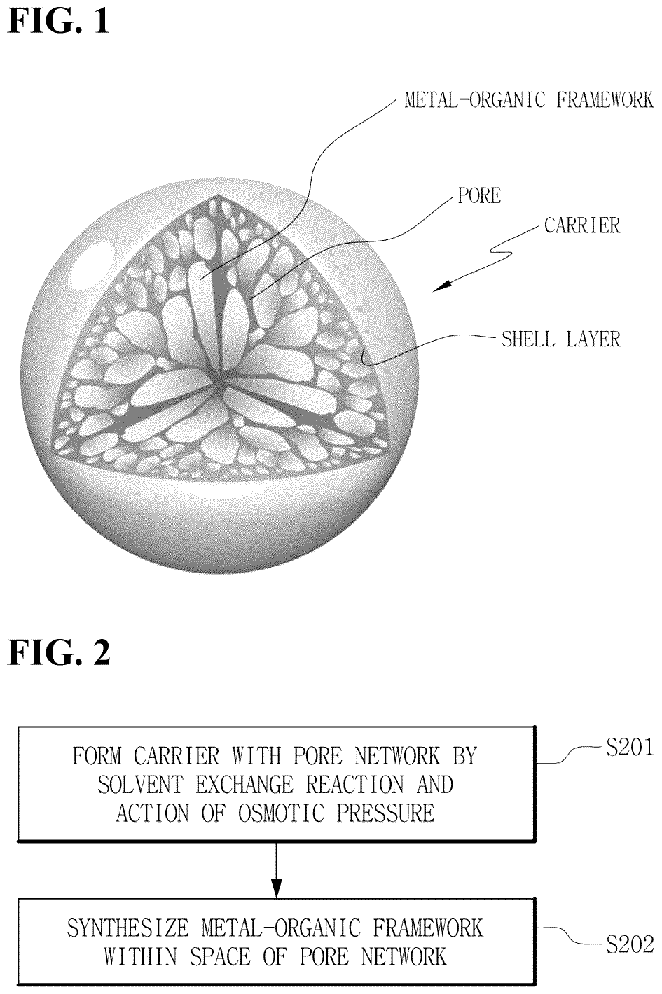

The present invention proposes an adsorbent in which a pore network is formed inside a millimeter-sized carrier, and metal-organic framework particles are filled within the space of the pore network (see FIG. 1).

As the carrier is millimeter-sized, the recovery of the adsorbent is naturally facilitated. Additionally, by filling (i.e. loading) the pore space inside the carrier with nanoscale metal-organic framework particles, the contact area of the metal-organic framework that can come into contact with metal ions may be prevented or minimized from being reduced by the carrier. With reference to the Experimental Example described below, the adsorption performance of the adsorbent (ZIF-8@PMC) according to the present invention, which has a structure where ZIF-8, a metal-organic framework, is filled within the pores of the PMC (PAN macrocapsule), for neodymium (Nd) and dysprosium (Dy), was almost identical to the adsorption performance of the ZIF-8 particles themselves for neodymium (Nd) and dysprosium (Dy). These experimental results indicate that the contact area of the metal-organic framework loaded in the form of being filled in the pore space inside the carrier, is hardly affected by the carrier. This contrasts with the results in Non-patent Document 3, where the metal-organic framework is provided in the form of being embedded in the support.

In the present invention, the term “pore network” refers to a structure in which the pores inside the carrier are interconnected in a network form, and some of these pores in the pore network may be configured in the form that is not connected to each other. That is, a plurality of pores exist in the form of being scattered or interconnected inside the carrier, and this pore structure inside the carrier will be referred to as a “pore network.” However, the overall structure of the pore network may be described as a radial form, arranged from the center of the carrier toward the shell layer.

The carrier may form a spherical shape, and the surface of the carrier is provided with a shell layer having a thickness of several to tens of micrometers. In addition, the shell layer is provided with surface pores that connect the inside and outside of the carrier (surface pores are not illustrated in the schematic view of FIG. 1). Through these surface pores, the influx of metal ions into the carrier is made possible. The size or diameter of the surface pores is smaller than that of the metal-organic framework particles, preventing the metal-organic framework inside the carrier from leaking out through the surface pores. Additionally, the size of the surface pores is smaller than that of solids, such as suspended solid materials, present in water, thus suppressing the flow of solids in water into the carrier through the surface pores. The size of the surface pores is approximately around 100 nm, while the size of the metal-organic framework particles is approximately several hundred nm.

Some of the pores forming the pore network of the carrier are spatially connected to the surface pores, while others are not spatially connected to the surface pores. That is, the pore network in some areas is spatially connected to the surface pores, while the pore network in other areas is not spatially connected to the surface pores.

In areas where the surface pores and the pore network are spatially connected, the metal ions that flow in through the surface pores are easily adsorbed by the metal-organic framework particles, which are present in the form of being filled within the pore network.

Even in areas where the surface pores and the pore network are not spatially connected, metal ions are still adsorbed by the metal-organic framework particles present in the corresponding pore network. The reason why metal ion adsorption is possible even though the surface pores and pore networks are not spatially connected may be explained by the following technical basis.

For example, when the carrier is made of polyacrylonitrile (PAN), PAN has nitrogen functional groups, which are a hydrophilic functional groups, and the nitrogen (N) of the nitrogen functional group easily bonds with the hydrogen (H) of water, causing water to be chemically absorbed into PAN. Since metal ions exist in a dissolved state in water, as water is absorbed by PAN, the metal ions dissolved in the water also flow into the PAN matrix, allowing the metal ions to pass through the PAN matrix. Through this mechanism, in the process in which metal ions pass through the PAN matrix, the metal ions are able to flow into the pores that are not connected to each other.

In this way, regardless of the spatial connection between the surface pores and the pore network, metal ions that pass through the surface pores either directly flow into the pore network or, metal ions introduced into the surface pores get through the process of passing through the PAN matrix and flow into the independently existing pore network, where they are adsorbed by the metal-organic framework particles. In this case, as described above, since the metal-organic framework particles are provided in the form of being filled within the pore network, the contact area of the metal-organic framework particles is not reduced by the influence of the carrier.

Whether the metal-organic framework particles are present in the form of being filled in the pore network or embedded in the carrier has an absolute impact on the metal ion adsorption capacity of the metal-organic framework particles. The present invention conducted experiments on this matter, and as referenced in the Experimental Example that will be described below, the adsorbent of the present invention, in which ZIF-8 exists in the form of being filled within the pore network of PMC, i.e., ZIF-8@PMC, showed results almost identical to the adsorption performance of ZIF-8 particles for neodymium (Nd) and dysprosium (Dy). In contrast, the adsorbent (ZIF-8/PMC) in which ZIF-8 exists in the form of being embedded in the PMC showed about half the adsorption performance compared to ZIF-8@PMC.

Meanwhile, the material that constitutes the carrier, i.e., the carrier material, needs to satisfy the following requirements.

The carrier is manufactured by dropping the carrier solution into a curing solution one drop at a time, and the carrier material is a polymeric material that needs to have the characteristics of being readily soluble in the solvent of the carrier solution but insoluble in the curing solution.

Additionally, it is preferable to use a polymeric material that has hydrophilic functional groups for the carrier material. As described above, in areas where the pore network is not spatially connected to the surface pores, metal ions need to pass through the carrier matrix and move into the pore network where the metal-organic framework particles are loaded. The movement of these metal ions is premised on the hydrophilicity of the carrier. That is, by having hydrophilic functional groups, the carrier allows water, in which metal ions are dissolved, to be absorbed into the carrier, enabling the metal ions to pass through the carrier matrix and move into the pore network.

As long as the above requirements are met, there are no specific limitations in selecting the carrier material. Examples of materials that meet the above requirements include polyacrylonitrile (PAN), polymethylmethacrylate (PMMA), polyacrylic acid (PAA), polyurethane (PU), polyimides (PI), polyaniline (PANI), polyvinyl alcohol (PVA), and polyvinylpyrrolidone (PVP). The carrier may be composed of any one of these materials or a combination thereof.

Additionally, the metal-organic framework loaded in the form of being filled within the pore network of the carrier needs to have excellent adsorption capacity for metal ions. Furthermore, since the synthesis of the metal-organic framework needs to take place within the pore network, it should have the characteristic that metal ions and ligands may be immediately combined at room temperature and synthesized into the metal-organic framework. Metal-organic frameworks that satisfy these characteristics include ZIF series metal-organic frameworks such as ZIF-8 and ZIF-67, as well as HKUST-1, MIL-88B, CAU-1, MOF-5, etc. Any one of these or a combination thereof may be used to form the metal-organic framework particles loaded within the pore network.

As described above, the adsorbent according to the present invention has the feature of minimizing the interference of the metal ion adsorption capacity of the metal-organic framework by the carrier through the structure in which the metal-organic framework particles exist in the form of being filled in the pore network inside the carrier.

Therefore, the adsorption performance of the adsorbent according to the present invention is expressed from the carrier with a pore network and the structure in which the metal-organic framework particles exist in the form of being filled in the pore network. This structure of the adsorbent according to the present invention is completed through a method of manufacturing the adsorbent, as described below.

The method of manufacturing the adsorbent according to the present invention is broadly divided into the process of manufacturing a carrier with a pore network (S201) and the process of forming a metal-organic framework within the space of the pore network (S202) (see FIG. 2).

First, the process of manufacturing a carrier with a pore network (S201) is as follows.

The carrier solution is prepared.

The carrier solution is a solution in which the carrier material is dissolved. The carrier material, being a polymeric material, needs to have the characteristic of being easily soluble in the carrier solvent of the carrier solution, but not dissolving in the curing solution. Additionally, it is preferable to use a polymeric material with hydrophilic functional groups as the carrier material. As an example, any one of polyacrylonitrile (PAN), polymethylmethacrylate (PMMA), polyacrylic acid (PAA), polyurethane (PU), polyimides (PI), polyaniline (PANI), polyvinyl alcohol (PVA), or polyvinylpyrrolidone (PVP), or a combination thereof may be used as the carrier material Additionally, the carrier solvent of the carrier solution may be a polar organic solvent capable of dissolving the carrier material. As an example, any one of N,N-dimethylformamide (DMF), dimethyl sulfoxide (DMSO), toluene, hexane, or dimethylacetamide (DMAc) may be used.

Next, the carrier solution is dropped in the form of droplets, one drop at a time, into the curing solution to manufacture a carrier with a pore network.

When the carrier solution is dropped into the curing solution in the form of droplets, the droplet is converted into a carrier with a shell layer and a pore network due to the solvent exchange reaction and the action of osmotic pressure. The curing solution serves to harden the droplets, and a solution that does not dissolve the carrier material may be used. As an example, a solution of water and ethanol mixed together may be used as the curing solution.

The process in which the droplet is converted into a carrier with a shell layer and a pore network is as follows in detail.

When the carrier solution is dropped into the curing solution one drop at a time, the carrier solvent contained in the droplet and the curing solution diffuse and exchange with each other. That is, the carrier solvent components within the droplet are expelled into the curing solution, and the space where the carrier solvent was expelled is filled with the curing solution. Through this reaction, a carrier with a shell layer and a pore network is formed. When this process is further broken down, it may be divided into the processes of forming a shell layer, increasing in osmotic pressure, and forming a pore network.

When the carrier solution is dropped into the curing solution one drop at a time, solvent exchange occurs rapidly from the surface of the droplet, forming a shell layer on the surface of the droplet. The shell layer is formed by the rapid removal of the carrier solvent components from the surface of the droplet, and it has a thin thickness with numerous surface pores. The surface pores of the shell layer correspond to the areas where the carrier solvent components from the surface of the droplet have escaped. The reason the shell layer is thin is that, due to the solvent exchange, once the thickness of the shell layer reaches a certain thickness, the carrier solvent inside the droplet may not easily escape through the surface pores of the shell layer. The shell layer is formed with a thickness of several to tens of micrometers, and the surface pores have a size of approximately around 100 nm.

With the shell layer formed, the carrier solvent inside the droplet may not be expelled through the pores of the shell layer, causing osmotic pressure to act within the droplet. The osmotic pressure acts most strongly at the center of the droplet.

In this state, when the osmotic pressure inside the droplet exceeds a critical point, that is, when the osmotic pressure inside the droplet becomes greater than the pressure exerted by the curing solution on the droplet, the carrier solvent inside the droplet is ejected in an instant, forming a pore network inside the droplet. Since osmotic pressure acts most strongly at the center of the droplet, and the droplet forms a spherical shape, the carrier solvent inside the droplet is ejected in all directions from the center of the droplet. As a result, the overall shape of the pore network takes on a radial form. In this case, the carrier solvent is ejected through the pores of the shell layer into the curing solution. Here, the pore network, as described above, is a combination of pores existing inside the carrier. Some of the pores may be formed in an interconnected form, while others may remain unconnected.

The carrier formed by the aforementioned solvent exchange reaction and the action of osmotic pressure has a size of several to tens of millimeters. The pores formed inside the carrier have a size of several micrometers to several millimeters. Additionally, the surface pores formed in the shell layer of the carrier, as described above, have a size of approximately around 100 nm.

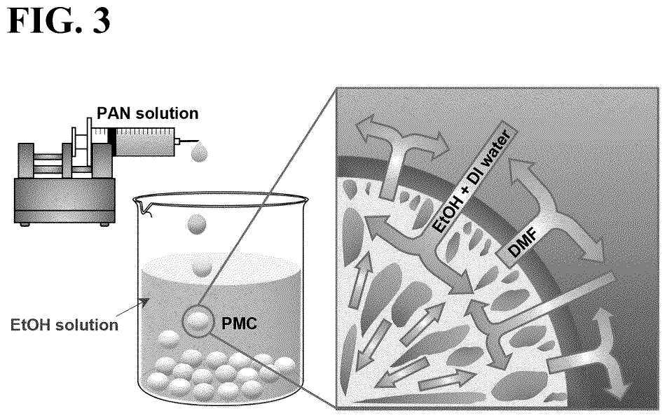

FIG. 3 is a reference view for describing the process of manufacturing a carrier with a pore network, schematically illustrating the process in which a carrier with a pore network is manufactured through the solvent exchange reaction and the action of osmotic pressure by the dropping of the PAN solution.

Once the carrier is manufactured, the process of forming the metal-organic framework within the space of the pore network (S202) is carried out.

First, the carrier formed by the solvent exchange reaction and the action of osmotic pressure is immersed in a ligand solution. The ligand solution is a solution in which the ligand is dissolved, and the ligand reacts with the metal ions that constitute the metal-organic framework, thereby serving to form the metal-organic framework (MOF). The ligand solution for forming the metal-organic framework may be a known ligand solution, and in the Experimental Example described below, a 2-methyl imidazole (2-MIM) solution was used as the ligand solution for forming ZIF-8.

As the carrier is immersed in the ligand solution, the pore network inside the carrier becomes completely filled with the ligand solution.

Next, the carrier filled with the ligand solution is removed and immersed in a metal solution. The metal solution is a solution containing the metal that constitutes the metal-organic framework.

As the carrier filled with the ligand solution is immersed in the metal solution, a counter-diffusion reaction occurs within the pore network space. Through the mutual diffusion of metal ions and ligands, the metal-organic framework particles are formed.

As the metal-organic framework particles are formed through the mutual diffusion of metal ions and ligands within the pore network space, the formed metal-organic framework particles exist in the form of being filled in the space of the corresponding pore network.

The adsorbent manufactured using this method is clearly contrasted with conventional technologies that use a support. In case of Non-patent Document 3, it has a structure in which the metal-organic framework is fixed in the form of being embedded in alginate beads, which is a support. In contrast, the adsorbent according to the present invention has a structure in which metal-organic framework particles are filled within the space of the pore network, rather than being embedded in the carrier or fixed to the carrier using separate functional groups.

Additionally, in the present invention, the formation of the metal-organic framework particles occurs within the space of the pore network (in-situ) through the mutual diffusion of metal ions and ligands via the influx of the ligand solution and metal solution into the pore network. As a result, metal-organic framework particles may be filled into the space of the pore network through a very simple method.

In addition, the formed metal-organic framework particles have a size of several hundred nanometers, making it highly unlikely that the metal-organic framework particles will be leaking out through the surface pores of the shell layer, which has a size of approximately around 100 nm. Since the metal-organic framework particles are loaded in the form of being filled within the pore network, the metal ion adsorption capacity of the metal-organic framework is not compromised. Moreover, because the metal-organic framework particles in the pore network are unlikely to be lost to the outside, the adsorption performance of the metal-organic framework may be stably maintained for a long period of time.

Meanwhile, in forming the metal-organic framework particles, the order of immersion into the ligand solution and the metal solution may be reversed and applied. That is, after immersing the carrier in the metal solution, the carrier may then be removed and immersed in the ligand solution, which may also form the metal-organic framework particles. However, in case of the former method, that is, using the order of immersion into the ligand solution followed by immersion into the metal solution, the amount of metal-organic framework synthesized is significantly greater compared to when the order is reversed and applied. For example, in the synthesis of Zn-ZIF-L described below, when the former method is applied, the amount of Zn-ZIF-L synthesized is approximately five times greater compared to when the latter method is used. The reason for this is due to the fact that the diffusion rate of Zn²⁺ is greater than the diffusion rate of 2-MIM molecules. This difference in diffusion rates causes the synthesis of the metal-organic framework to occur within the pore network space in case of the former method, while in case of the latter method, the relatively high diffusion rate of Zn²⁺ leads to the synthesis of the metal-organic framework occurring relatively outside the pore network space.

Regarding the formation of metal-organic framework particles, a more specific embodiment is described as follows. Taking ZIF-8 as an example of a metal-organic framework particle, the following method may be applied. In this case, the method of manufacturing a carrier with a pore network is applied in the same manner. The carrier with a pore network is immersed into the ligand solution. As an example, a 2-MIM solution may be used as the ligand solution. As the carrier is immersed in the 2-MIM solution, the pore network space of the carrier becomes filled with the 2-MIM solution.

Next, the carrier filled with the 2-MIM solution is removed and immersed in a solution containing Zn. As a result, the mutual diffusion of Zn ions and 2-MIM occurs within the pore network space of the carrier, leading to the formation of Zn-ZIF-L particles.

Zn-ZIF-L particles, like ZIF-8, are also metal-organic frameworks with excellent adsorption capacities for metal ions, particularly for neodymium (Nd) and dysprosium (Dy). However, Zn-ZIF-L has the characteristic of being relatively more soluble in water compared to ZIF-8. Therefore, a process is required to convert Zn-ZIF-L into ZIF-8 in order to ensure stability in water. Referring to the Experimental Example described below, the adsorbent loaded with Zn-ZIF-L particles showed the results that when immersed in water, the Zn-ZIF-L particles decomposed within a day.

In the state where Zn-ZIF-L particles are loaded in the form of being filled within the pore network space of the carrier, when the carrier in which Zn-ZIF-L particles are filled in the pore network is immersed in an ethanol solution, a phase change occurs in which the interlayer bonding of Zn-ZIF-L is broken and rearranged into ZIF-8. In this case, in addition to the ethanol solution, a methanol solution may also be used.

Through the above process, an adsorbent with ZIF-8 particles filled in the pore network space of the carrier may be produced.

Meanwhile, the reason for going through the Zn-ZIF-L synthesis process rather than directly synthesizing ZIF-8 particles is as follows. In the process of the present invention described above, the solvents for the ligand solution and the metal solution are water or ethanol. However, when directly synthesizing ZIF-8 particles, methanol is used. Methanol, compared to water and ethanol, is highly toxic and has a significantly negative impact on the environment. Additionally, when methanol is used as the solvent to directly synthesize ZIF-8 particles, the amount of ZIF-8 particles produced is only one-third compared to when water is used as the solvent and the Zn-ZIF-L synthesis process is followed before synthesizing ZIF-8 particles.

Further, while it is possible to directly synthesize ZIF-8 particles using water as the solvent, in this case, 70 times the amount of 2-MIM compared to Zn ions is required. In contrast, when water is used as the solvent and the Zn-ZIF-L synthesis process is followed to synthesize ZIF-8, only twice the amount of 2-MIM compared to Zn ions is required. Therefore, directly synthesizing ZIF-8 using water as the solvent is highly uneconomical.

In the process described above, the order of immersion of the carrier into the 2-MIM solution and into the solution containing Zn may be reversed and applied when forming the Zn-ZIF-L particles.

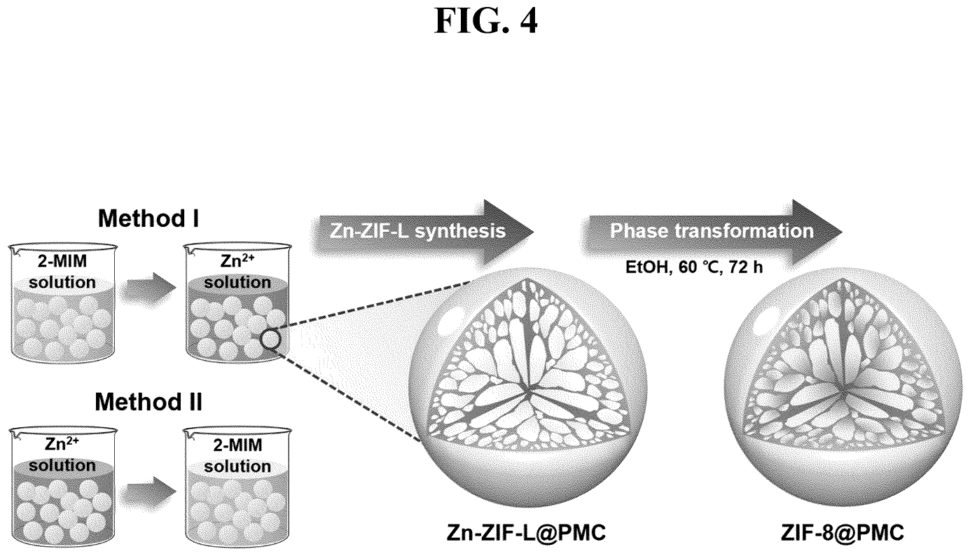

FIG. 4 illustrates the process of forming ZIF-8 particles in the pore network of the carrier (PMC).

The above describes the adsorbent in which a metal-organic framework is loaded within the pore space of the carrier and the method of manufacturing the same, according to an embodiment of the present invention. Hereinafter, the present invention will be described in more detail through the Experimental Examples.

### Experimental Example 1: Manufacture of Carrier with Shell Layer and Pore Network

Polyacrylonitrile (PAN, MW=80,000 g/mol) was dissolved in N,N-dimethylformamide (DMF) to prepare a PAN solution with a PAN content of 3 to 17 wt %. A curing solution was prepared by mixing ethanol and distilled water in a 1:1 ratio. The PAN solution was placed into a 50 ml syringe, and an 18G needle was attached. Using a syringe pump, the PAN solution was dropped into the curing solution at a rate of 0.5 mL/min. While dropping the PAN solution, the curing solution was stirred, and to remove the DMF that had escaped from the droplets of the PAN solution, the curing solution was replaced at least five times. The synthesized carrier (PMC, PAN macrocapsule) was removed and dried at 80° C. for 24 hours.

### Experimental Example 2: Synthesis of Zn-ZIF-L in Pore Network Space

An experiment was conducted to form Zn-ZIF-L particles in the pore network of the carrier (PMC) manufactured according to Experimental Example 1.

### Method I

30 g of PMC manufactured according to Experimental Example 1 was immersed in 20 mL of a 2M 2-MIM solution and stirred for 4 hours to ensure that the inside of the PMC was fully filled with 2-MIM. Next, the PMC was removed and immersed in 20 mL of a 1M zinc solution, where Zn-ZIF-L was synthesized within the pore network space inside the PMC (25° C., 24 hours). Then, the PMC with the formed Zn-ZIF-L (Zn-ZIF-L@PMC) was removed, washed several times with ultrapure water, and dried at 80° C. for 24 hours (see FIG. 4).

### Method II

The Zn-ZIF-L@PMC was manufactured by reversing the order of Method I.

In detail, 30 g of PMC, manufactured according to Experimental Example 1, was immersed in 20 mL of a 1M zinc solution and stirred for 4 hours to ensure that Zn²⁺ was fully filled inside the PMC. Next, the PMC was removed and immersed in 20 mL of a 2-MIM solution, where Zn-ZIF-L was synthesized within the pore network space of the PMC (25° C., 24 hours). Then, the PMC with the formed Zn-ZIF-L (Zn-ZIF-L@PMC) was removed, washed several times with ultrapure water, and dried at 80° C. for 24 hours (see FIG. 4).

### Experimental Example 3: Synthesis of ZIF-8 in Pore Network Space

2 g of Zn-ZIF-L@PMC, manufactured by Method I and II of Experimental Example 2, was immersed in 100 mL of an ethanol solution and reacted at 60° C. for 72 hours, converting Zn-ZIF-L into ZIF-8. As a result, an adsorbent (ZIF-8@PMC), provided in the form in which ZIF-8 is filled within the pore network space of the carrier, was manufactured. Next, the ZIF-8@PMC was washed at least three times with ethanol and then vacuum-dried for 24 hours.

### Experimental Example 4: Synthesis of ZIF-8/PMC

To compare with the ZIF-8@PMC manufactured by Experimental Example 3, an adsorbent (ZIF-8/PMC), existing in the form in which ZIF-8 is embedded in the PMC, was manufactured.

The same process as in Experimental Example 1 was conducted, but instead of using the PAN solution from Experimental Example 1, a solution in which ZIF-8 particles were dispersed in the PAN solution was applied.

### Experimental Example 5: Characteristics of PMC Manufactured by Experimental Example 1

The morphology of the PMC manufactured by Experimental Example 1 was analyzed.

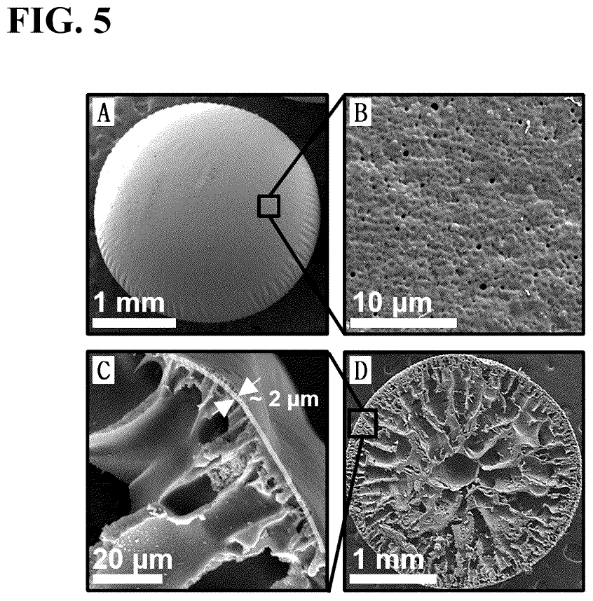

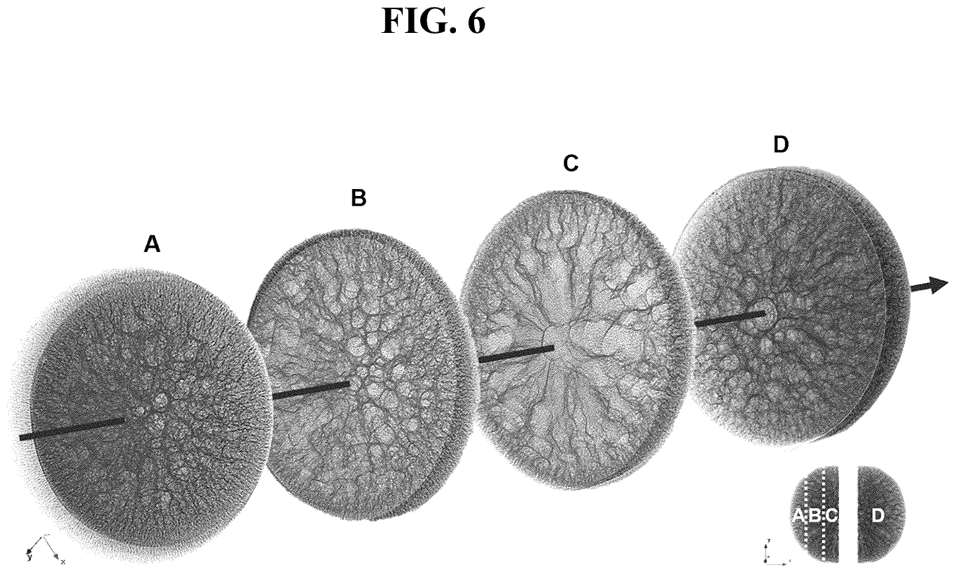

FIG. 5 is an SEM image of the PMC manufactured by Experimental Example 1. With reference to B and C of FIG. 5, it can be confirmed that a shell layer of approximately 2 μm thickness is formed, and surface pores are formed in the shell layer with uniform distribution. Additionally, with reference to D of FIG. 5, it can be confirmed that a pore network, consisting of a combination of interconnected and unconnected pores, is formed inside the carrier, in a radial form. FIG. 6 illustrates the reconstructed PMC image from the micro CT image of the PMC manufactured by Experimental Example 1, showing the structure of the pore network.

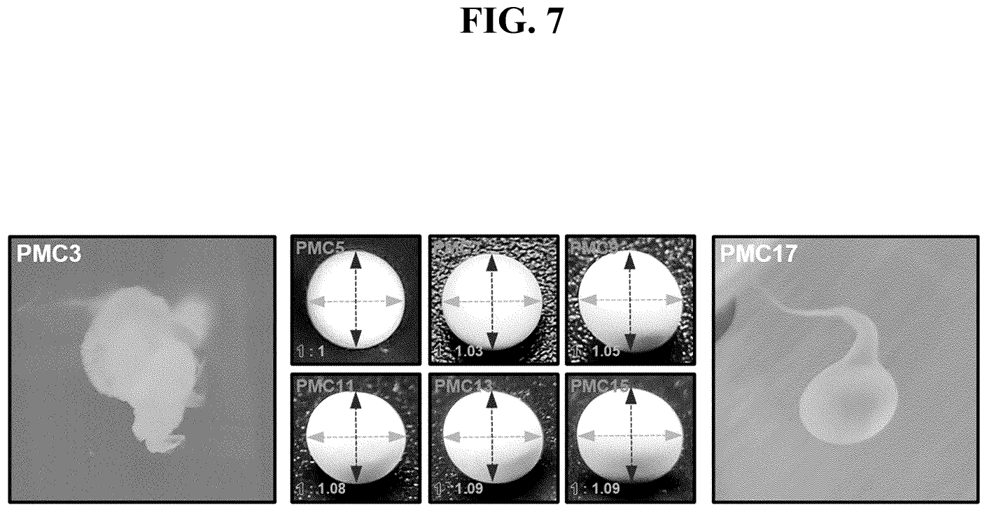

FIG. 7 illustrates photographs of PMC manufactured with varying PAN content according to Experimental Example 1. In case where the PAN content is 3 wt % (PAN3), it can be confirmed that the ratio of PAN is too low to maintain a spherical capsule structure. Additionally, in case where the PAN content is 17 wt % (PAN17), the ratio of PAN is too high, causing the viscosity of the droplet to increase. As a result, when dropped into the curing solution, the droplet was also synthesized in a form that is not spherical with an elongated tail shape. In contrast, when the PAN content is 5 to 15 wt % (PMC5 to PMC15), it can be confirmed that the spherical shape with an aspect ratio of up to 1.09 is maintained.

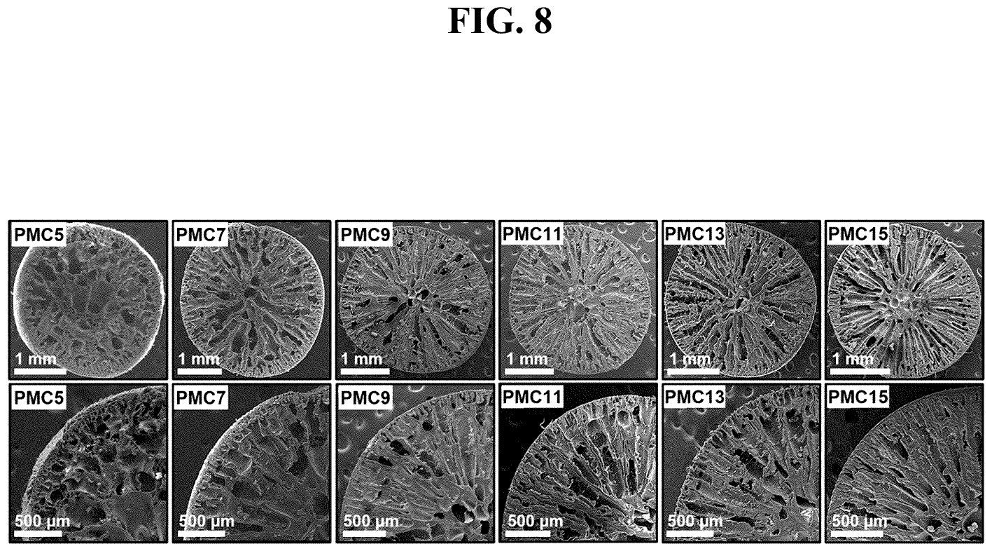

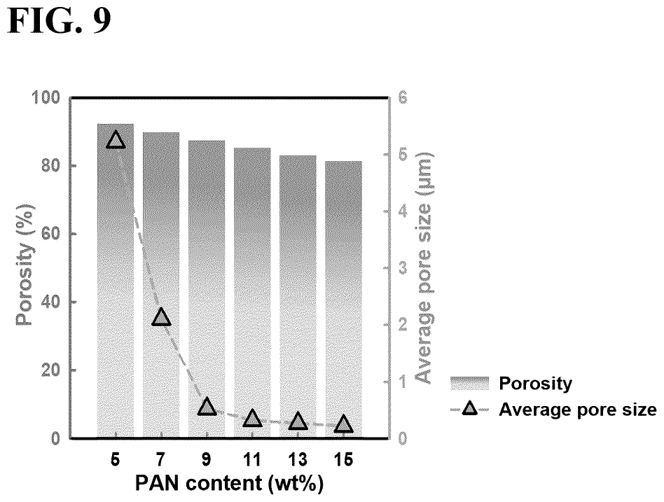

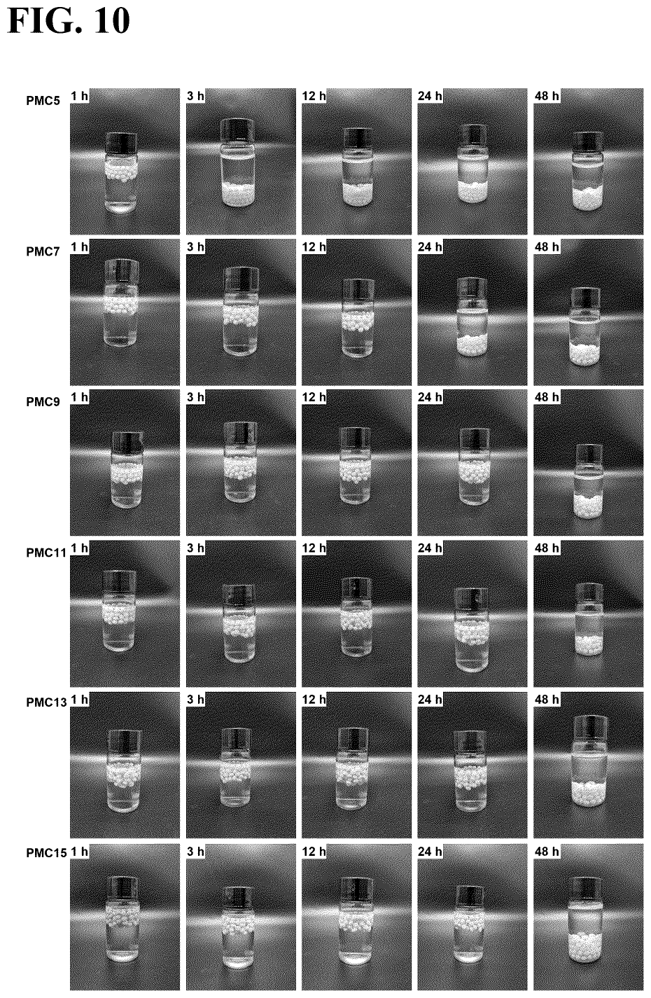

Additionally, SEM analysis was conducted on PMC5 to PMC15, which were manufactured with PAN content of 5 to 15 wt % applied (see FIG. 8). As a result, it can be confirmed that as the PAN content increases, the pore size decreases and a denser structure is formed. Additionally, the porosity and average pore size of PMC5 to PMC15 were measured (see FIG. 9). The porosity of all the PMC5 to PMC15 was measured to be 80% or more, with no significant difference in porosity. However, it was found that as the PAN content increased, the average pore size decreased sharply. Due to these characteristics, it can be confirmed through the permeability experiment illustrated in FIG. 10 that as the PAN content increases, the permeability of PMC decreases.

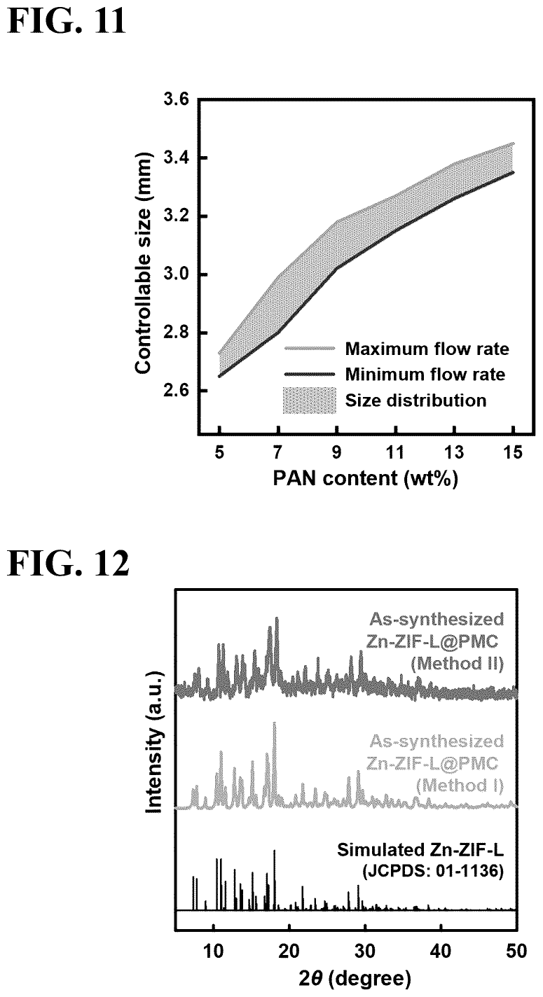

Additionally, to investigate whether the droplet rate of the PAN solution affects the formation of PMC in Experimental Example 1, PMC was manufactured with varying droplet rates (0.2 to 1.2 mL/min) applied (see FIG. 11). The results confirmed that, despite varying the droplet rate, uniform-sized spherical PMC was manufactured for the cases where the PAN content was 5 to 15 wt %.

### Experimental Example 6: Analysis of Zn-ZIF-L@PMC Manufactured by Method I and II

The characteristics of the Zn-ZIF-L@PMC manufactured according to Method I and II of Experimental Example 2 were analyzed.

FIG. 12 illustrates the XRD analysis results for Zn-ZIF-L@PMC manufactured according to Method I and II, respectively. It can be confirmed that Zn-ZIF-L was successfully synthesized in both cases.

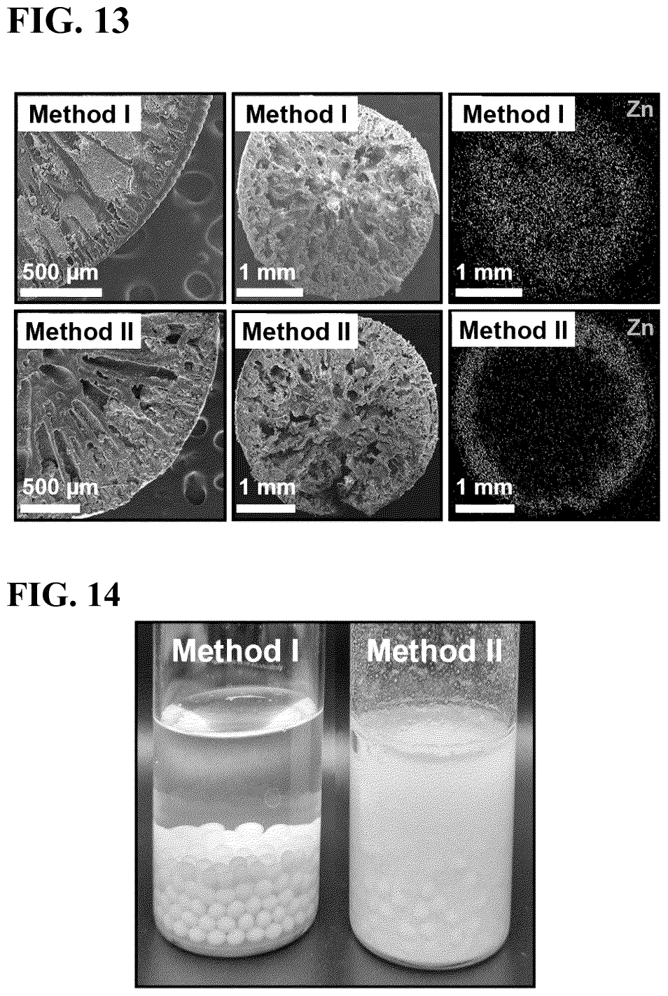

FIG. 13 illustrates the SEM-EDS analysis results for Zn-ZIF-L@PMC manufactured according to Method I and Method II, respectively. With reference to FIG. 13, in case of Zn-ZIF-L@PMC manufactured by Method I, it can be confirmed that Zn-ZIF-L is uniformly and tightly filled throughout the entire PMC carrier and within the pore network space. In contrast, in case of Zn-ZIF-L@PMC manufactured by Method II, it can be observed that Zn-ZIF-L is distributed along the outer areas of the PMC. These results are due to the fact that the diffusion rate of Zn²⁺ is greater than the diffusion rate of 2-MIM molecules. This is because the difference in these diffusion rates causes the synthesis of Zn-ZIF-L to occur within the pore network space in case of Method I, while in Method II, the relatively high diffusion rate of Zn²⁺ leads to the synthesis of Zn-ZIF-L at the outer areas of the PMC.

The influence of the diffusion rate difference between Zn²⁺ and 2-MIM molecules on the synthesis of Zn-ZIF-L can also be confirmed through FIG. 14. FIG. 14 illustrates photographs taken during the synthesis process according to Method I and Method II. It can be observed that in Method I, even after immersing the PMC loaded with 2-MIM inside in the Zn solution, the solution remains transparent, whereas in Method II, the outside turns white and cloudy in an instant.

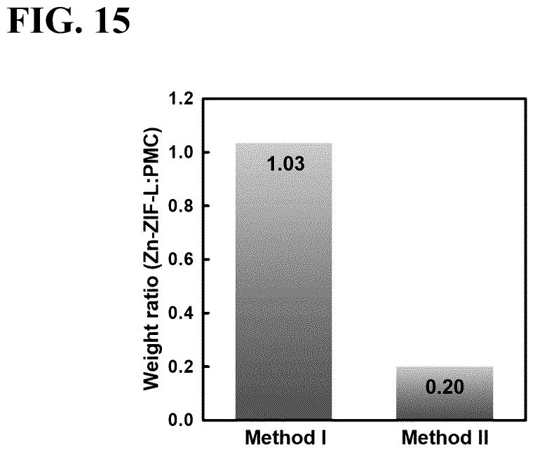

Additionally, the difference in the diffusion rates of Zn²⁺ and 2-MIM molecules also affects the amount of Zn-ZIF-L synthesized. With reference to FIG. 15, it can be confirmed that the amount of Zn-ZIF-L synthesized in Method I is at least five times greater compared to Method II.

### Experimental Example 7: Analysis of Phase Change of Zn-ZIF-L to ZIF-8

FT-IR and XRD analyses were conducted on ZIF-8@PMC manufactured by Experimental Example 3 to analyze the phase change of Zn-ZIF-L into ZIF-8.

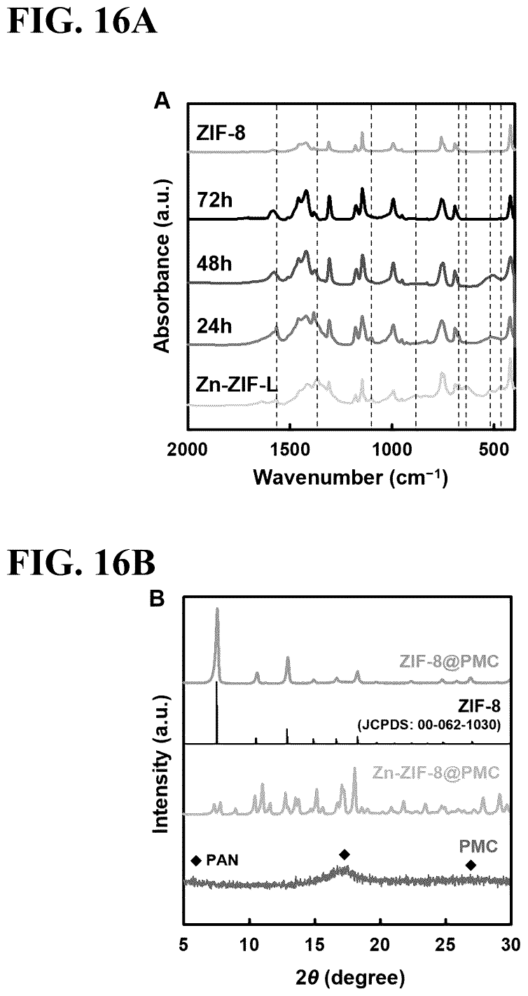

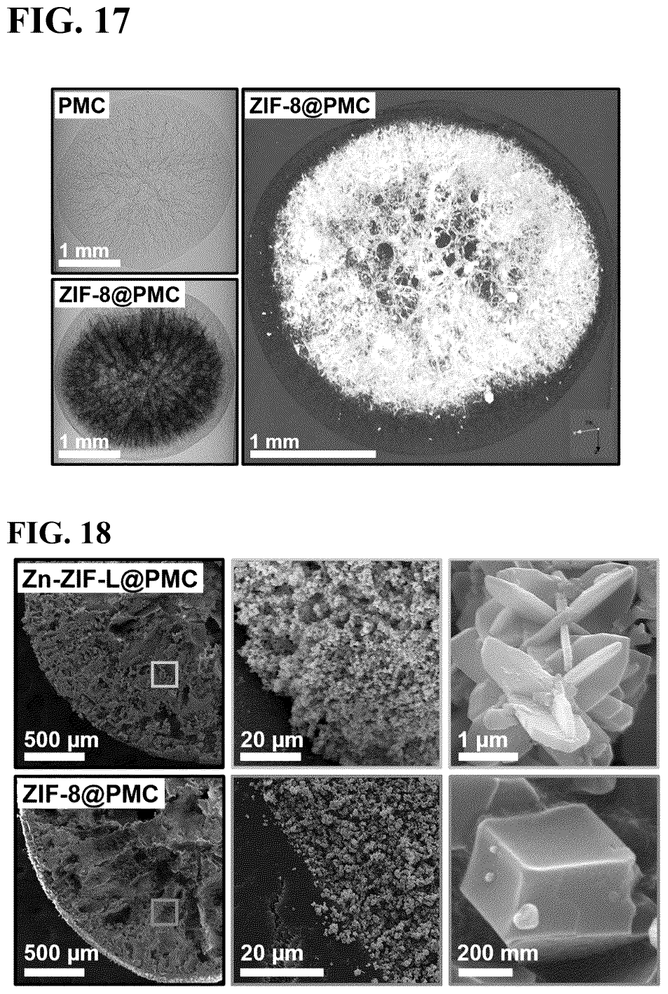

Referring to the FT-IR analysis results in FIG. 16A, it can be seen that after 72 hours of ethanol immersion of Zn-ZIF-L@PMC according to Experimental Example 3, the Zn-ZIF-L is completely converted into ZIF-8. This can be also confirmed through the XRD analysis results in FIG. 16B. Additionally, the successful synthesis of ZIF-8 can also be confirmed through the micro CT image and reconstructed image in FIG. 17.

SEM analysis was conducted on both Zn-ZIF-L@PMC manufactured by Experimental Example 2 and ZIF-8@PMC manufactured by Experimental Example 3 (see FIG. 18). As a result, it can be confirmed that changes in the morphology and size of the PMC carrier occurred.

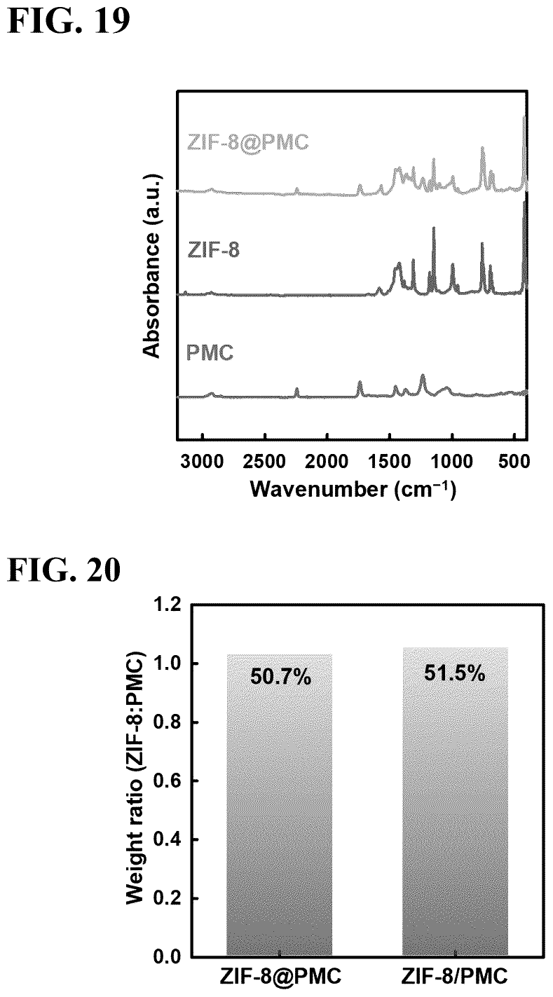

Meanwhile, FT-IR analysis was conducted on ZIF-8@PMC manufactured by Experimental Example 3 (see FIG. 19). As a result, it can be confirmed that the spectra of both ZIF-8 and PMC are included, indicating that the synthesis of ZIF-8 was successfully carried out. Additionally, this result shows that there were no chemical changes in the PMC during the synthesis of ZIF-8 within the pore network space of the PMC.

### Experimental Example 8: Comparison of Characteristics of ZIF-8@PMC and ZIF-8/PMC

The characteristics of ZIF-8@PMC manufactured by Experimental Example 3 and ZIF-8/PMC manufactured by Experimental Example 4 were analyzed.

The results of calculating the weight ratio of ZIF-8 in ZIF-8@PMC and ZIF-8/PMC (see FIG. 20) showed that the weight ratio of ZIF-8 in the two materials was similar, calculated as 50.7% and 51.5%, respectively.

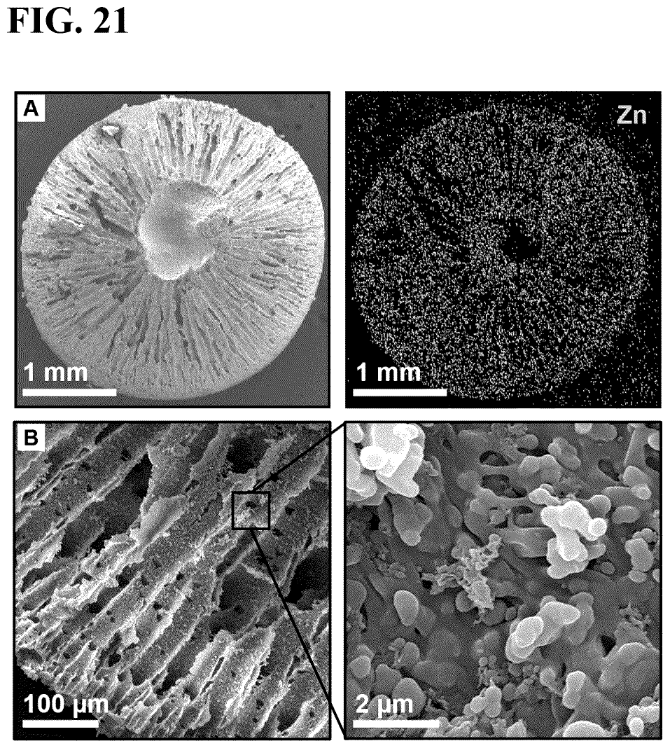

Additionally, SEM-EDS analysis was conducted on ZIF-8/PMC (see FIG. 21A), and it was confirmed that, similar to ZIF-8@PMC, ZIF-8 is present throughout the entire PMC. In contrast, when examining the enlarged SEM image inside the carrier of ZIF-8/PMC (see FIG. 21B), it can be confirmed that ZIF-8 exists in the form of being embedded within the PMC matrix. This result contrasts with that of ZIF-8@PMC, where the ZIF-8 particles exist in the form of being filled within the pore network space of the PMC.

In addition, the adsorption performance of ZIF-8@PMC and ZIF-8/PMC for neodymium (Nd) and dysprosium (Dy) was evaluated, respectively. The conditions for the adsorption experiment are as follows.

Nd and Dy solutions with a concentration of 1000 ppm were used, and the pH of the solution was adjusted to 6. Equal amounts of pure ZIF-8 particles, ZIF-8/PMC, and ZIF-8@PMC were added to this solution, respectively and reacted for 24 hours at 25° C., stirring at 150 rpm.

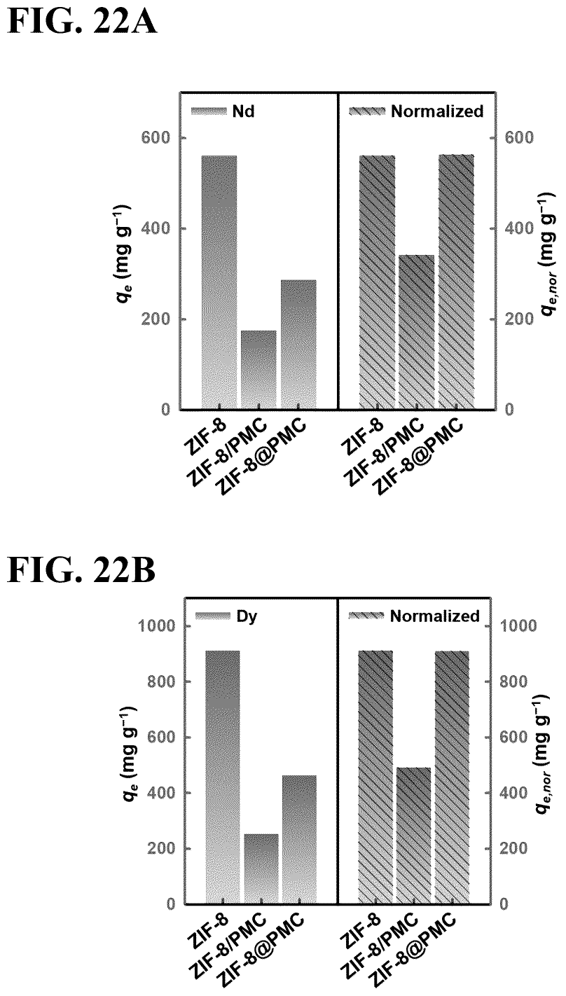

FIG. 22A illustrates the adsorption amounts of ZIF-8@PMC and ZIF-8/PMC for neodymium (Nd), respectively and FIG. 22B illustrates the adsorption amounts of ZIF-8@PMC and ZIF-8/PMC for dysprosium (Dy), respectively. In FIG. 22A and FIG. 22B, the ‘normalized’ experimental results are the result of correcting the adsorption amounts by subtracting the weight of the PMC from ZIF-8@PMC and ZIF-8/PMC, respectively, and considering only the weight of the ZIF-8 filled inside.

With reference to FIG. 22A and FIG. 22B, the ‘normalized’ adsorption amount of ZIF-8@PMC was found to be almost identical to the adsorption amount of pure ZIF-8. In contrast, ZIF-8/PMC showed about half the adsorption performance compared to the ‘normalized’ adsorption amount of ‘ZIF-8@PMC’ even after being ‘normalized’. These results are believed to be due to the fact that ZIF-8@PMC is provided in the form in which ZIF-8 particles are filled in the pore network space of the PMC, which does not reduce the activity of the ZIF-8 particles, while ZIF-8/PMC is present in the form in which ZIF-8 is embedded in the PMC matrix, which reduces the activity of ZIF-8, i.e. the contact area.

### Experimental Example 9: Adsorption Capacity of ZIF-8@PMC for Rare Earth Metals

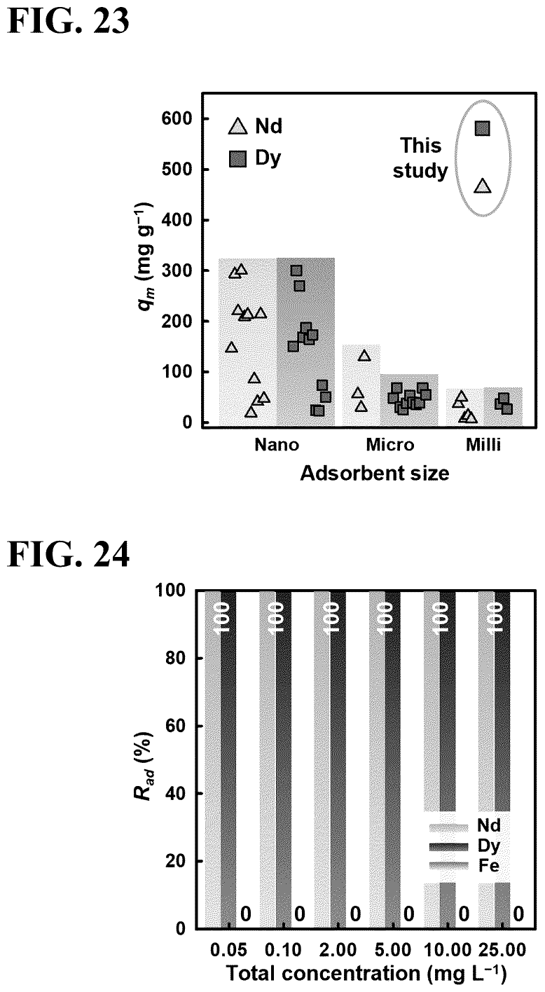

The maximum adsorption amounts for neodymium (Nd) and dysprosium (Dy) in ZIF-8@PMC manufactured by Experimental Example 3 were measured, respectively (see FIG. 23). The results showed that the maximum adsorption amount for neodymium (Nd) was 463.6 mg/g, and the maximum adsorption amount for dysprosium (Dy) was 580 mg/g. These results indicate significantly superior adsorption performance compared to well-known adsorbents for neodymium (Nd) and dysprosium (Dy) with millimeter, micrometer, and nanometer sizes.

Additionally, adsorption experiments for neodymium (Nd) and dysprosium (Dy) were conducted using a solution simulating the eluate of waste permanent magnets. In detail, a solution simulating the eluate of a waste permanent magnet, composed of Fe, Nd, and Dy with weight ratios of 65, 25, and 10 wt %, was prepared. In this case, the total concentration of the three elements was set in the range of 0.05 to 25 mg/L, and the pH of the simulated solution was adjusted to 6 using a 0.1 M NaOH solution. Then, ZIF-8@PMC manufactured by Experimental Example 3 was added to the simulated solution.

As illustrated in the adsorption experiment results (see FIG. 24), only neodymium (Nd) and dysprosium (Dy) were selectively adsorbed 100% by ZIF-8@PMC. In contrast, under pH 6 conditions, Fe was converted into the form of ferric oxide and precipitated. For reference, Nd and Dy exist as trivalent cations without any precipitate up to pH 7, while Fe has the characteristic of precipitating from pH 4 or higher.

Additionally, to assess the impact of the shell layer on the adsorption performance, ZIF-8@PMC was split into a hemispherical shape and added to the waste permanent magnet eluate simulation solution. The adsorption performance was then evaluated. The conditions for the waste permanent magnet eluate simulation solution were applied the same as in the above experiment.

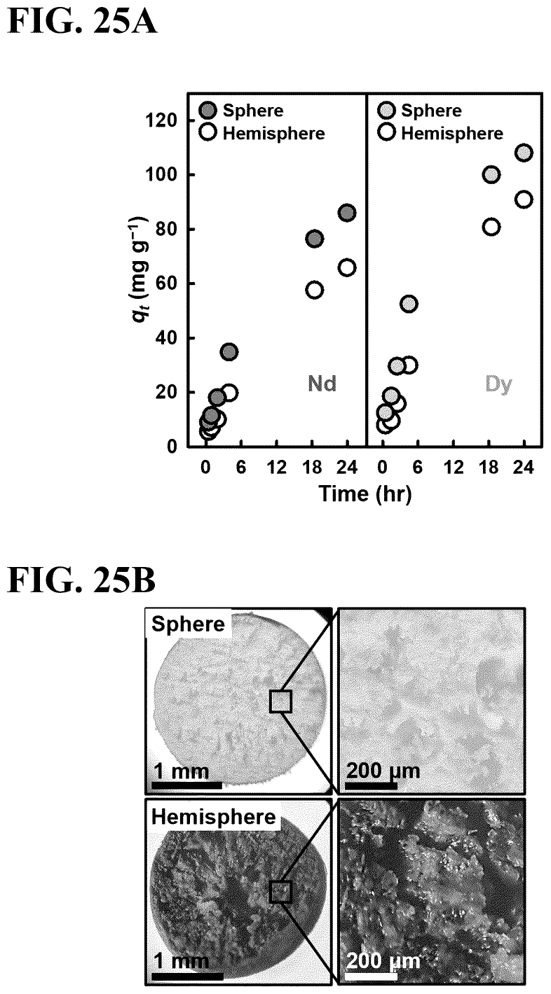

As illustrated in FIG. 25A, the experiment result showed that the spherical ZIF-8@PMC exhibited higher adsorption performance over time for both Nd and Dy compared to the hemispherical ZIF-8@PMC. In case of spherical ZIF-8@PMC with a shell layer, as illustrated in FIG. 25B, the shell layer prevents the penetration of dissolved solids into the PMC, allowing the smooth adsorption of rare earth metals by ZIF-8. In contrast, in case of hemispherical ZIF-8@PMC, the function of the shell layer to prevent the penetration of dissolved solids is lost, resulting in a large amount of dissolved solids penetrating into the PMC. These penetrated dissolved solids block the surface of the ZIF-8 particles, leading to a decrease in the adsorption capacity of ZIF-8 for rare earth metal.

In addition, the adsorption performance of ZIF-8@PMC was evaluated upon reuse. The rare earth metal adsorption was conducted by adding ZIF-8@PMC to the aforementioned waste permanent magnet eluate simulation solution. Then, the rare earth metals adsorbed on ZIF-8@PMC were desorbed using a 0.05 M EDTA-2Na solution. This adsorption and desorption process was repeated five times, and the adsorption performance of ZIF-8@PMC was evaluated each time.

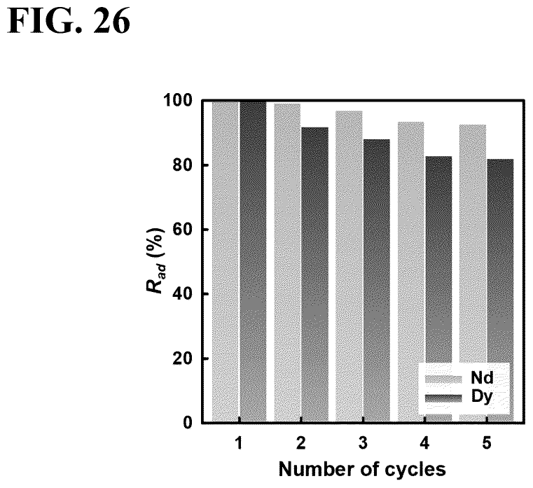

The experimental results showed that even after repeating the adsorption and desorption process five times, Nd exhibited a recovery rate of 92.5% and Dy exhibited a recovery rate of 81.8%, confirming that excellent adsorption performance for rare earth metals was exhibited even when reused through regeneration (see FIG. 26).

### Experimental Example 10: Stability in Water and Pressure Drop Characteristics of ZIF-8@PMC

To evaluate the stability in water of ZIF-8@PMC manufactured by Experimental Example 3, 0.02 g of ZIF-8@PMC (containing approximately 0.01 g of ZIF-8) and 0.01 g of ZIF-8 particles were immersed in 100 mL of ultrapure water. Samples were taken at predetermined time intervals (1 day, 7 days) and XRD analysis was performed.

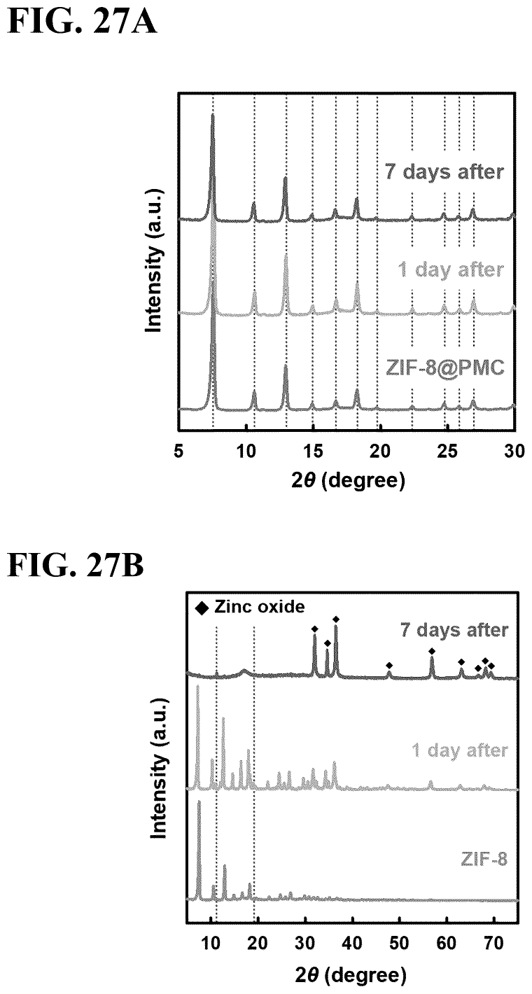

The XRD analysis results showed that, in case of ZIF-8@PMC, no changes in the XRD pattern were observed even after 7 days, indicating high stability in water (see FIG. 27A). In contrast, in case of the ZIF-8 particles, new XRD peaks were observed starting after one day, and after 7 days, they had completely oxidized into the form of zinc oxide (see FIG. 27B). As far as is known, ZIF-8 has unstable characteristics in water when it is present at 0.75 wt % or less compared to water. In this experiment, the ratio of ZIF-8 particles to water was 0.01 wt %, which is why ZIF-8 was oxidized in a relatively short period of time. In contrast, in case of ZIF-8@PMC, it is believed that the stability in water is secured because the amount of water flowing inside the PMC is limited due to the presence of ZIF-8 in the pore network of the PMC.

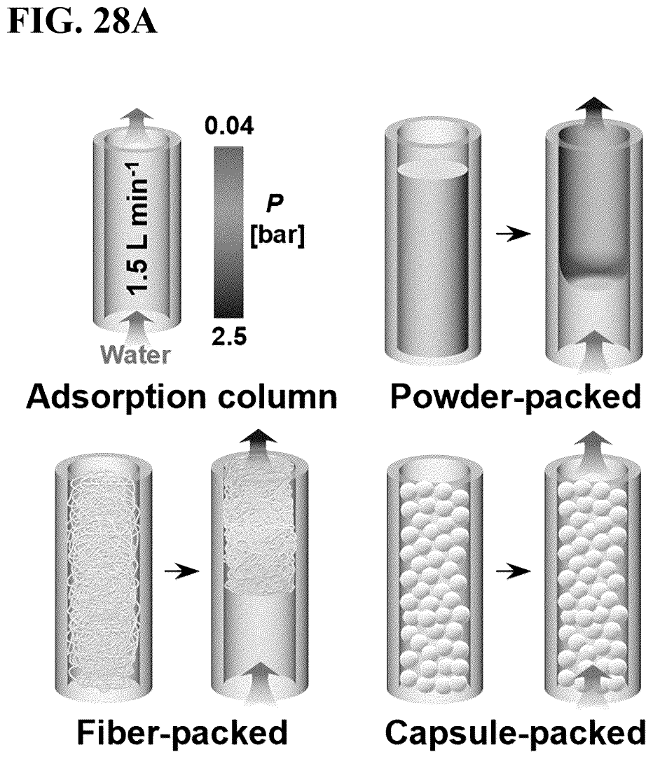

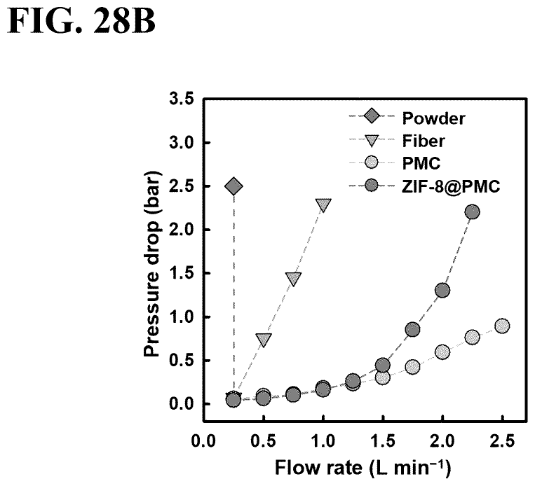

The pressure drop characteristics of ZIF-8@PMC manufactured by Experimental Example 3 were examined when packed in a continuous flow column. For comparison, the same amount of PAN particles, PAN fibers, and PMC were also packed into the continuous flow column, respectively, and their pressure drop characteristics were then examined (see FIG. 28A).

The experimental results showed that PMC had the lowest pressure drop, and ZIF-8@PMC exhibited significantly lower pressure drop characteristics compared to PAN particles and PAN fibers. In case of the PMC, since ZIF-8 is not filled in the pores, it exhibited the best pressure drop characteristics. On the other hand, even though ZIF-8 is filled in the pore network of PMC, ZIF-8@PMC still exhibited excellent pressure drop characteristics due to the porous structure of PMC (see FIG. 28B).

What is claimed is:

1. An adsorbent in which a metal-organic framework is filled within a pore space of a carrier, comprising:
a carrier having a shell layer on a surface thereof and pores inside; and
metal-organic framework particles loaded in a form of being filled in the pore space.

2. The adsorbent of claim 1, wherein the shell layer is provided with surface pores that connect an inside and an outside of the carrier, and metal ions in water are capable of flowing into the inside of the carrier through the surface pores.

3. The adsorbent of claim 2, wherein a size of the surface pores is smaller than a size of the metal-organic framework particles, preventing the metal-organic framework particles from leaking out of the carrier.

4. The adsorbent of claim 2, wherein a size of the surface pores is smaller than a size of solids in water, so that the solids in water do not flow into the carrier.

5. The adsorbent of claim 1, wherein the carrier is made of a polymeric material having hydrophilic functional groups.

6. The adsorbent of claim 5, wherein the carrier is made of any one of polyacrylonitrile (PAN), polymethylmethacrylate (PMMA), polyacrylic acid (PAA), polyurethane (PU), polyimides (PI), polyaniline (PANI), polyvinyl alcohol (PVA), or polyvinylpyrrolidone (PVP), or a combination thereof.

7. The adsorbent of claim 1, wherein the metal-organic framework particles are made of any one of ZIF-series metal-organic frameworks, HKUST-1, MIL-88B, CAU-1, or MOF-5, or a combination thereof.

8. The adsorbent of claim 1, wherein metal ions in water flow into the carrier through surface pores of the shell layer and are adsorbed onto the metal-organic framework particles.

9. A method of manufacturing an adsorbent in which a metal-organic framework is filled within a pore space of a carrier, comprising:
manufacturing a carrier having a shell layer and pores; and
allowing synthesis of metal-organic framework particles to proceed within the pore space of the carrier.

10. The method of claim 9, wherein the manufacturing of the carrier having the shell layer and pores includes:
preparing a carrier solution and a curing solution; and
dropping the carrier solution into the curing solution one drop at a time to form the carrier with the shell layer and pores by a solvent exchange reaction and an action of osmotic pressure, and
wherein surface pores that connect an inside and an outside of the carrier are formed in the shell layer during the forming of the carrier with the shell layer and pores.

11. The method of claim 10, wherein:
metal ions in water are capable of flowing into the inside of the carrier through the surface pores;
a size of the surface pores is smaller than a size of the metal-organic framework particles, preventing the metal-organic framework particles from leaking out of the carrier; and
the size of the surface pores is smaller than a size of solids in water, so that the solids in water do not flow into the carrier.

12. The method of claim 10, wherein the carrier solution is a solution in which a carrier material is dissolved and the carrier material is made of a polymeric material having hydrophilic functional groups, and
wherein the carrier material is made of any one of polyacrylonitrile (PAN), polymethylmethacrylate (PMMA), polyacrylic acid (PAA), polyurethane (PU), polyimides (PI), polyaniline (PANI), polyvinyl alcohol (PVA), or polyvinylpyrrolidone (PVP), or a combination thereof.

13. The method of claim 9, wherein the allowing synthesis of metal-organic framework particles to proceed within the pore space of the carrier includes:
immersing the carrier in a ligand solution to fill the pore space of the carrier with the ligand solution; and
immersing the carrier filled with the ligand solution in a metal solution and allowing metal ions and ligands to react within the pore space to form the metal-organic framework.

14. The method of claim 9, wherein the allowing synthesis of metal-organic framework particles to proceed within the pore space of the carrier includes:
immersing the carrier in a metal solution to fill the pore space of the carrier with metal ions; and
immersing the carrier filled with the metal ions in a ligand solution and allowing the metal ions and ligands to react to form the metal-organic framework.

15. The method of claim 9, wherein the metal-organic framework particles are made of any one of ZIF-series metal-organic frameworks, HKUST-1, MIL-88B, CAU-1, or MOF-5, or a combination thereof.

16. A method of manufacturing an adsorbent in which a metal-organic framework is filled within a pore space of a carrier, comprising:
manufacturing a PAN carrier with a shell layer and pores;
synthesizing Zn-ZIF-L particles within a pore space of the PAN carrier; and
converting the Zn-ZIF-L particles into ZIF-8 particles.

17. The method of claim 16, wherein the manufacturing of the PAN carrier having the shell layer and pores includes:
preparing a PAN solution and a curing solution; and
dropping the PAN solution into the curing solution one drop at a time to form the PAN carrier with the shell layer and pores by a solvent exchange reaction and an action of osmotic pressure,
wherein surface pores that connect an inside and an outside of the PAN carrier are formed in the shell layer during the forming of the PAN carrier with the shell layer and pores.

18. The method of claim 16, wherein the synthesizing of Zn-ZIF-L particles within the pore space of the PAN carrier includes:
immersing the PAN carrier in a ligand solution to fill pores of the PAN carrier with the ligand solution; and
immersing the PAN carrier filled with the ligand solution in a Zn solution and allowing Zn²⁺ ions and ligands to react within the pore space and form Zn-ZIF-L particles.

19. The method of claim 18, wherein the converting of the Zn-ZIF-L particles into the ZIF-8 particles includes:
immersing the PAN carrier, filled with the Zn-ZIF-L particles in the pore space of the PAN carrier, in a solution to convert the Zn-ZIF-L particles into the ZIF-8 particles.

20. The method of claim 17, wherein a content of PAN in the PAN solution is 5 to 15 wt %.
